(19) United States
(12) Patent Application Publication
(10) Pub. No.: US 2011/0024051 A1
(43) Pub. Date: Feb. 3, 2011

(54) Automated lamination stacking system for a transformer core former

(76) Inventors: Kyle L. Sanford, Pine Bluff, AR (US); David B. Wood, White Hall, AR (US); Ronald J. Stahara, Pine Bluff, AR (US); Kenneth W. White, Cabot, AR (US); Steve P. Lux, Hot Springs Village, AR (US); Todd F. Bartelt, Lenexa, KS (US); Donald A. Gilmore, Kansas City, MO (US); Nathaniel W. Maholland, Gardner, KS (US); Eric Rolf, Kansas City, MO (US); Richard A. Sizemore, Lenexa, KS (US); Kevin Smith, Shawnee, KS (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 12/661,474

(22) Filed: Mar. 18, 2010

Related U.S. Application Data
(60) Provisional application No. 61/210,608, filed on Mar. 20, 2009.

(51) Int. Cl. B32B 38/04; B25J 15/08

(52) U.S. Cl. 156/355; 901/31

(57) ABSTRACT

An automated steel lamination stacking system for a transformer core. A computer controlled robot arm with a machine vision system locates each of a series of laminations formed by a core former. A hand with a pair of fingers disposed on the end of the robot arm sequentially grasps each of the laminations and transfers each lamination to a forming table which receives and shapes each lamination into a stack to form the desired transformer core. As the empty hand returns to retrieve the next lamination, an extended arm is activated to square the stack. If the preset number of laminations has been stacked and a desired weight has been reached, then the process is complete. Otherwise the stacking process continues. Because the laminations grow in size as the core is built, the stacking system adjusts the position of the fingers to grasp each lamination.

### CROSS-REFERENCE TO RELATED APPLICATIONS

This application claims the benefit of U.S. Provisional Patent Application No. 61/210,608 filed Mar. 20, 2009, the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to the manufacture of transformer cores, and in particular, to an automatic system for stacking laminations from a core former.

2. Brief Description of the Related Art

A transformer includes a core that is formed from multiple stacked or nested metal laminations. The size and shape of the laminations is determined by the type and size of core. However, even for a particular core, the size and shape of each lamination must vary in order for the laminations to stack or nest together tightly.

A core former is a machine that accepts information from an operator as to the parameters of the particular transformer core desired. The system receives a roll of sheet metal, determines the dimensions of each individual lamination and automatically forms and cuts a series of laminations that the operator manually stacks to produce the desired core.

The manual process for operating a core former requires that an operator be present and perform the following actions at each one of several stationary systems:

(1) Post setup, the operator must ensure that the system is active and find the appropriate core mold (typically an I-beam) matching the dimensions of the inner window of the core to ensure that the produced core maintain its form.

(2) The operator must place the core mold upon the operator's workstation, ensure that all proper dimensions are input into the system PC and sent to the core former. Assuming that all parameters are inputted, the system starts feeding steel to begin its forming process.

(3) As each lamination exits the core forming system, the operator must grab every descending lamination and place it around the core mold, occasionally adjusting the build to ensure that the laminations fit securely.

(4) Upon completion of the core, the operator must move the core to a scale to ensure that core meets weight tolerances. If so, the operator must then bind the core with mild steel strapping, label the core and move the core to a conveyor for loading. If not, the operator must execute a build-up operation for additional laminations and continuously re-weigh until the core reaches the required weight.

The limitations of the prior art are overcome by the present invention as described below.

### BRIEF SUMMARY OF THE INVENTION

The present invention is a stacking system that operates in conjunction with a transformer core former. The present invention comprises a computer controlled robot arm with a machine vision system to locate each of a series of laminations formed by a core former and a hand and fingers to sequentially grasp each of the laminations and to transfer each lamination to a forming table which receives and shapes each lamination into a stack to form the desired transformer core. As used herein, the term “hand” refers to the entire robot end-of-arm tooling structure and the term “finger” refers to an apparatus located on the hand that procures the laminations with the use of any form of grasping mechanism. “Core” refers to a transformer core produced by stacking a set amount (in weight) of laminations. “Lamination” refers to a strip of core steel of a predetermined length, width, and shape. The term “extended arm” refers to a mechanism to square the most recently stacked lamination.

The stacking system of the present invention is loaded with the parameters for a particular type and size of transformer core. In particular, the system requires information about the current core, such as the size of the core (or size of beginning lamination) and desired total weight. This information may be obtained automatically from the core former or another type of input may be used.

When producing a lamination, the core former stops at a preset point before making the final cut that separates the lamination from the sheet metal coil. Once the stacking system has obtained the lamination, the final cut is made and the stacking system moves the lamination toward the stack area. The stacking system places the lamination over the existing stack, closes the fingers to shape the lamination and releases the lamination. As the empty hand returns to retrieve the next lamination, the extended arm is activated to square the stack. If the preset number of laminations has been stacked and the core has reached the desired weight, then the process is complete. Otherwise the stacking process continues. Because the laminations grow in size as the core is built, the stacking system determines if the distance between the fingers needs to be adjusted to grasp each lamination.

After a preset number of laminations have been stacked, an integrated load cell weighs the core and compares it to a preset value. If the desired core weight is not reached, the stacking system signals the core former to produce extra laminations as needed.

The present invention requires that an operator be present and perform these actions at only one hub, which may operate multiple systems:

(1) Ensure that all proper dimensions are input into the system computer processing system, which may include a computer processing system (also referred to herein as a “CPU” or “PC”) associated with the core former and a separate computer processing system associated with the robot arm (referred to herein as a “robot controller”). Each of the CPU and the robot controller includes machine readable storage media on which sets of executable instructions reside. The CPU and robot controller may be connected with a communications link such as an Ethernet connection. Assuming that all parameters are input, the system starts feeding steel to begin its forming process.

(2) As each lamination (being built to the proper dimensions) exits the core former, the stacking system's end-of-arm tooling procures the descending laminations using a grasping mechanism and places each one around the preceding laminations, occasionally using an extended arm to adjust the build and ensure that the laminations fit securely.

(3) Upon completion of the core, a scale built into the workstation ensures that each core meets weight tolerances. If so, an off-loading mechanism moves the completed core to a conveyor for unloading. If not, the stacking system executes a build-up by having the core former produce additional laminations. The system continuously re-weigh on its own until the core reaches the required weight.

### BRIEF DESCRIPTION OF THE SEVERAL VIEWS OF THE DRAWINGS

These and other features, objects and advantages of the present invention will become better understood from a consideration of the following detailed description and accompanying drawing where:

FIGS. 1A-C comprise a flow chart of the steps carried out by one embodiment of the present invention.

FIG. 2 is a perspective view of an example of a transformer core former and decoiler machine.

FIG. 3 is a top plan view of one embodiment of the robot arm and forming table the present invention together with a core former and decoiler machine.

FIG. 4 is a top plan view of a transformer core comprising a series of laminations.

FIG. 5 is a block diagram of one embodiment of the present invention showing the interconnections between the computer processing systems, each having a computer readable storage medium on which a set of executable instructions reside for interfacing with and controlling the automatic operation of the various components of the stacking system.

FIG. 6 is a perspective view of one embodiment of the core former and forming table showing a disposition of laser line projectors with respect to a lamination formed but not yet cut off by the core former.

FIG. 7 is a perspective view of an embodiment of the robot arm and the tool including the hand and fingers at the end of the robot arm.

FIG. 8 is a perspective view of an embodiment of the hand and fingers.

FIG. 9 is a perspective view of the hand and fingers of FIG. 8 grasping a lamination.

FIG. 10 is a top plan view of an embodiment of the forming table.

FIG. 11 is a cross sectional side elevation view of an embodiment of the forming post.

FIG. 12 is a perspective view of an embodiment of the base of the forming table.

FIG. 13 is a perspective view of an embodiment of the forming table.

FIG. 14 is a top plan view of a partially formed transformer core showing a lamination loosely stacked onto the partially formed core.

FIG. 15 is a perspective view of the forming table of FIG. 10 showing an embodiment of the shapers.

FIG. 16A is a perspective view of one of the shapers of FIG. 15 showing the shaper in a first position in which it is disposed horizontally below the common plane of the forming table.

FIG. 16B is a perspective view of the shaper of FIG. 16A showing a second position in which it is disposed vertically in contact with the side of a lamination.

FIG. 16C is a perspective view of the shaper of FIG. 16B after it has been translated horizontally against the side of the lamination.

FIG. 17 is a perspective view of an embodiment of a shaper cam. This view is of a left shaper cam, that is, the shaper cam associated with the left carriage.

FIG. 18A is an partial cross sectional view of the shaper cam of FIG. 16C along the line 18A-18A with a shaper having rollers disposed in channels to impart stability to the shaper.

FIG. 18B is a partial cross section of the shaper cam of FIG. 18A along the lines 18B-18B.

FIG. 18C is a partial elevation view of the shaper cam of FIG. 17.

### DETAILED DESCRIPTION OF THE INVENTION

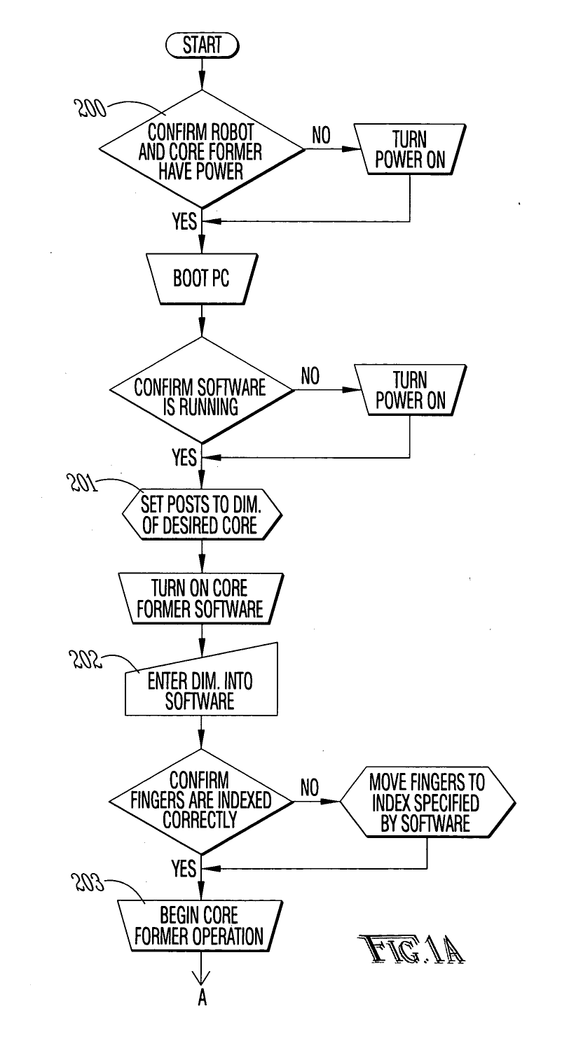

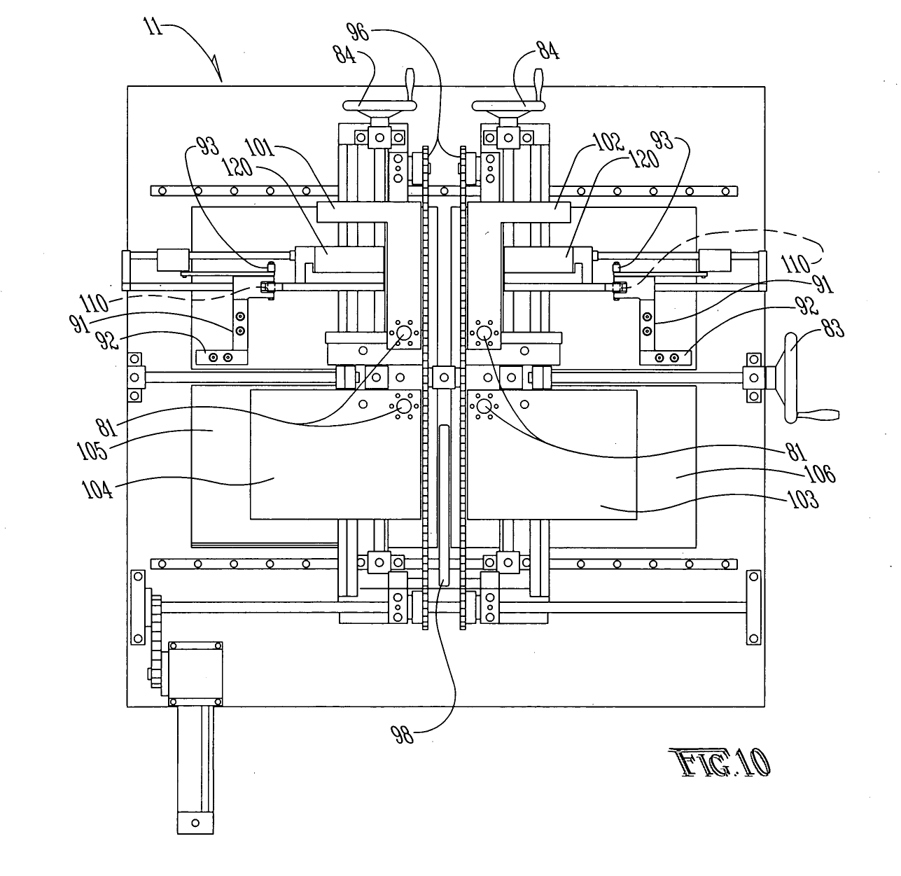

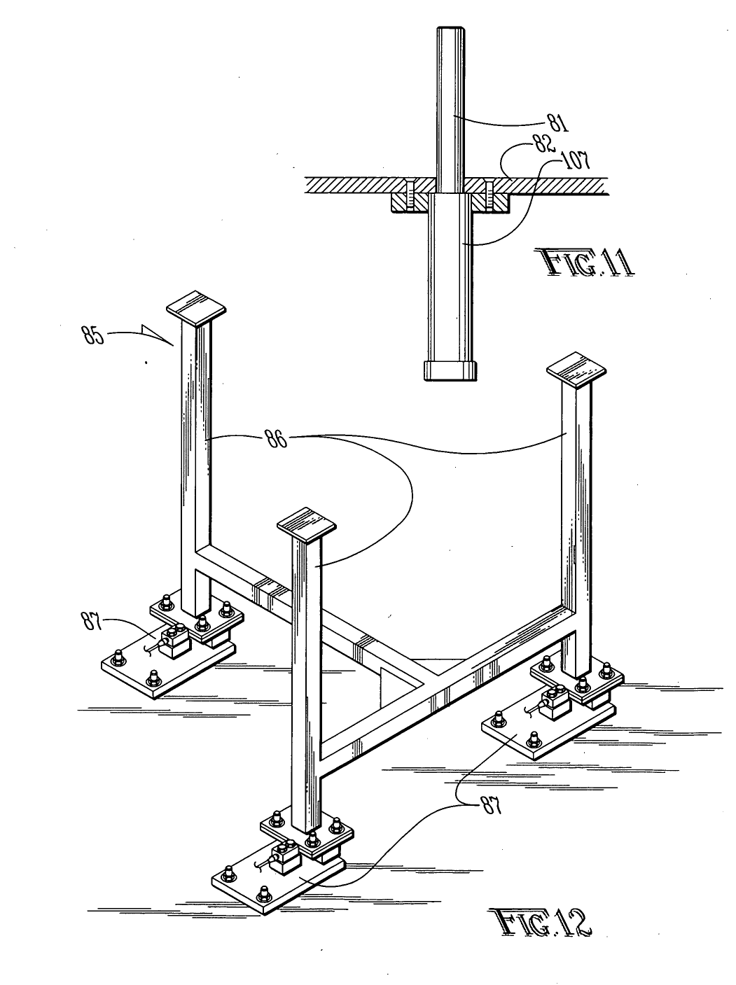

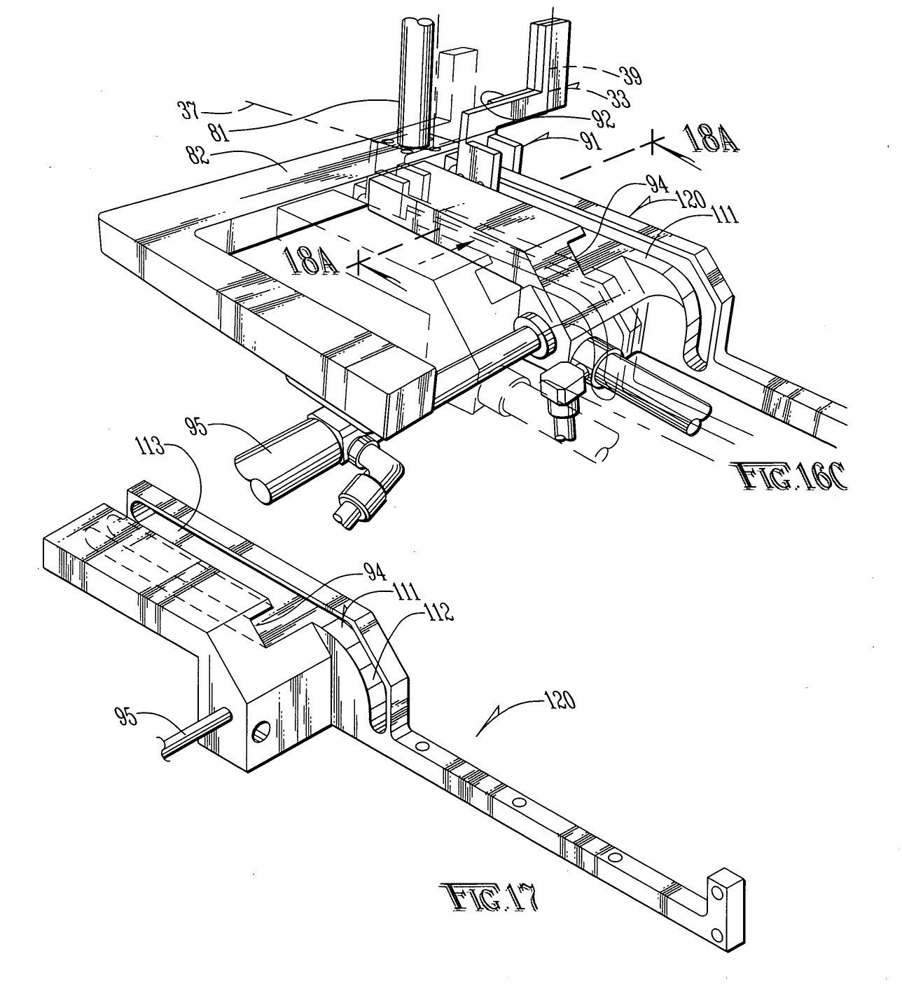

With reference to FIGS. 1-18C, the preferred embodiments of the present invention may be described as follows:

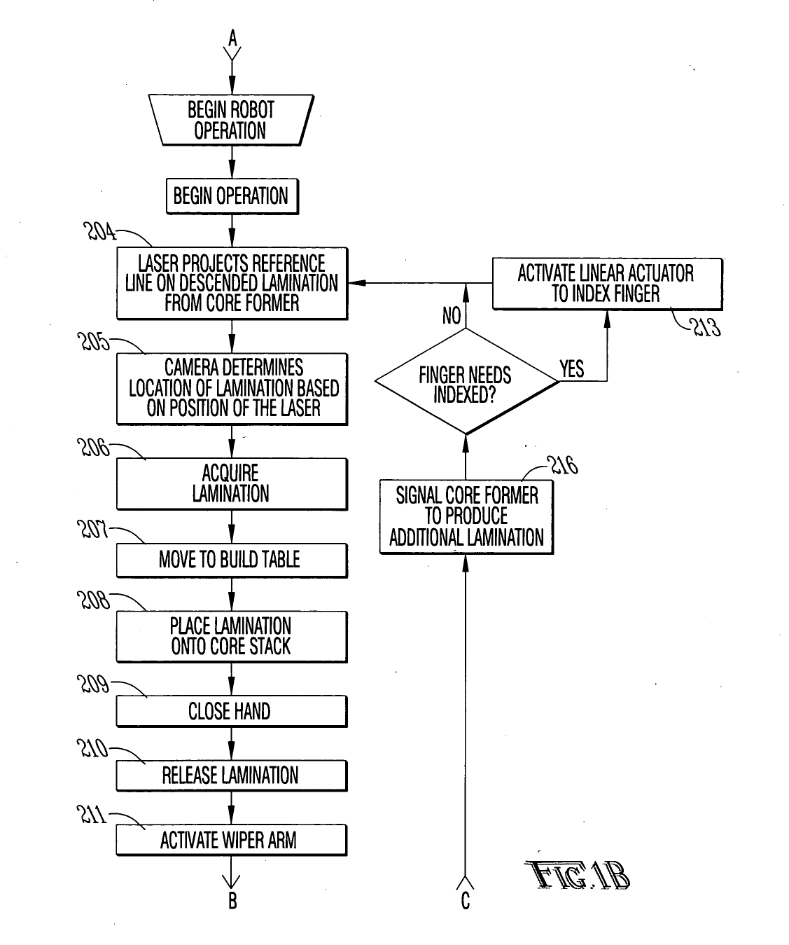

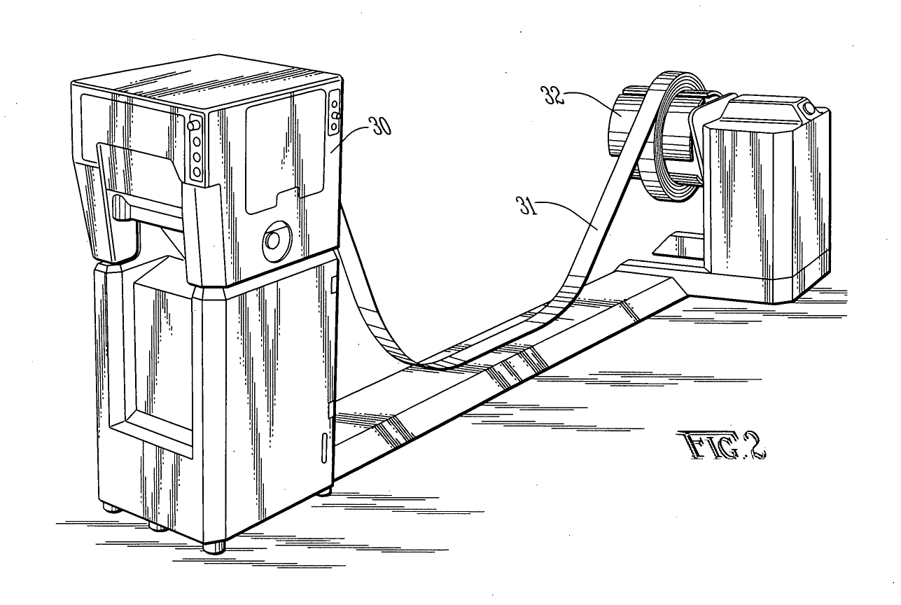

The present invention is a automated lamination stacking system that operates in conjunction with a transformer core former. With reference to FIGS. 2 and 4, a transformer core former 30 accepts information from an operator as to the parameters of a desired transformer core 35 (such as the dimensions of the window 34 in the center of the transformer core 35 and the desired final weight), receives a roll of sheet metal 31 (for example, from a decoiler machine 32), determines the dimensions of each of a series of laminations 33 and automatically forms and cuts a series of formed laminations 33 that may be stacked to produce the desired transformer core 35. As can readily be seen, each individual formed lamination 33 is formed with individually specific dimensions that allow it to be wrapped around each preceding lamination so as to form a tightly nested series of laminations. As used herein, the term “stack” refers to a partially formed core comprising a series of tightly nested laminations. The term “stack” is used interchangeably with the term “partially formed core.” Examples of a transformer core former and decoiler machine are the AEM Unicore UCM3000 and UDM4000 made by AEM Cores Pty. Ltd., Gillman, Australia.

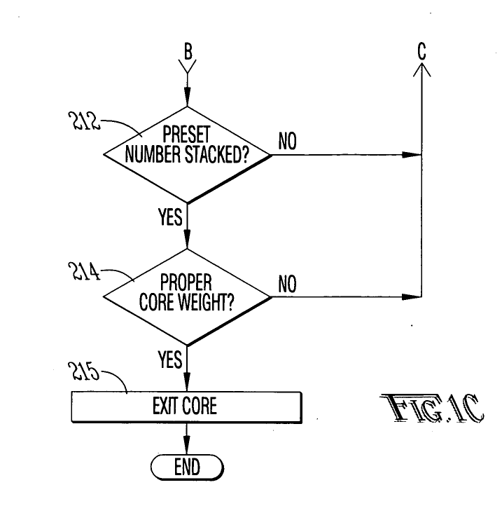

As shown in FIG. 3, the present invention comprises a computer controlled multi-axis robot arm 10, a machine vision system to locate each of a series of laminations formed by the core former 30 and a hand and fingers combination located at an end of the robot arm 10 to sequentially grasp each of the series of laminations and to transfer each lamination to a forming table 11 which receives and shapes each lamination into the stack until the desired transformer core is formed. The M-10iA™ six-axis industrial robot (FANUC Robotics America, Inc., Rochester Hill, Mich.) has been found to be suitable for the practice of the present invention. A robot controller 140 is associated with the robot arm 10 which controls the operation of the robot arm 10 and other portions of the system as described following.

The core former 30 forms a series of laminations 33 that together form the desired transformer core. The laminations are formed from a roll of metal 31. Each lamination 33 is formed with a number of creases corresponding to the corners of each lamination as it is stacked around the previous laminations to form the transformer core. Although not so limited, the operation of the system will be described with respect to one embodiment in which the creases define five segments of the lamination 33—the back 36 of the lamination 33, the two sides 37 of the lamination 33, a long segment 38 of the front of the lamination 33 and a short segment 39 of the front of the lamination 33. The long segment 38 and the short segment 39 when nested together meet to form the front 40 of the lamination 33. The lengths of each of the five segments 36, 37, 38, 39 are continuously adjusted by the core former 30 so that each lamination 33 is formed with the correct dimensions to nest securely around each previous lamination. After shaping the lamination 33 to produce the creases at the appropriate locations, the final action of the core former 30 is to cut each lamination 33 free from the metal roll 31. The core former 30 carries out these actions automatically after being provided with the desired core sizes by the operator 41.

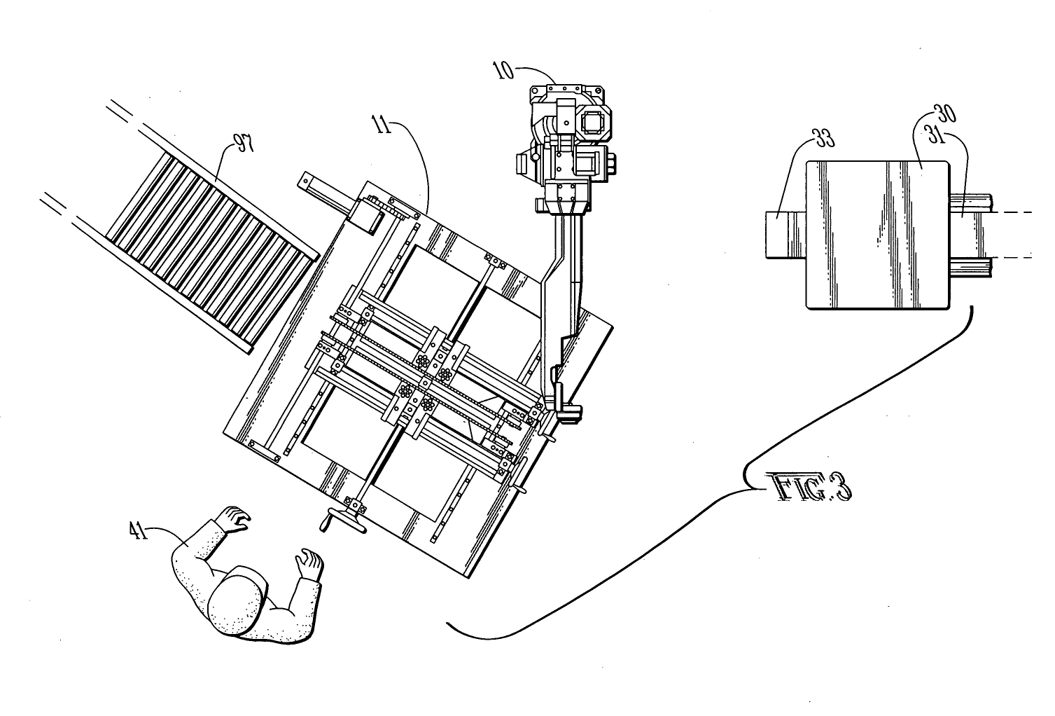

The core former 30 is operated by a set of executable software instructions residing on computer readable media associated with the core former 30. Such software will necessarily be modified to interface with the executable software instructions that operate the stacking system of the present invention. The software instructions for the stacking system of the present invention comprise a set of executable instructions residing on computer readable storage media associated with the computer processing system CPU 50 and interfaced with and controlling the automatic operation of the core former 30. The CPU 50 also receives information from load cells 87 and camera 64 as described herein. CPU 50 interfaces with a separate computer processing system referred to herein as a robot controller 140. Robot controller controls the operation of robot arm 10, hand 70, fingers 71, 72, shapers or wipers 91, and conveyors 96. Robot controller 140 received information from vacuum sensors 90. Robot controller 140 and CPU 50 are interfaced by means of a communications link 141 such as an Ethernet connection. FIG. 5 is a block diagram showing the interconnections between the CPU 50, robot controller 140 and the various components of the stacking system.

As the core former 30 produces each lamination 33, it stops before making the final cut. The lamination 33 hangs vertically from the core former 30 with the creases 62 in the lamination 30 oriented substantially horizontally. For a particular example of a core former 30, some structural modification may be required to allow the lamination 33 to hang vertically.

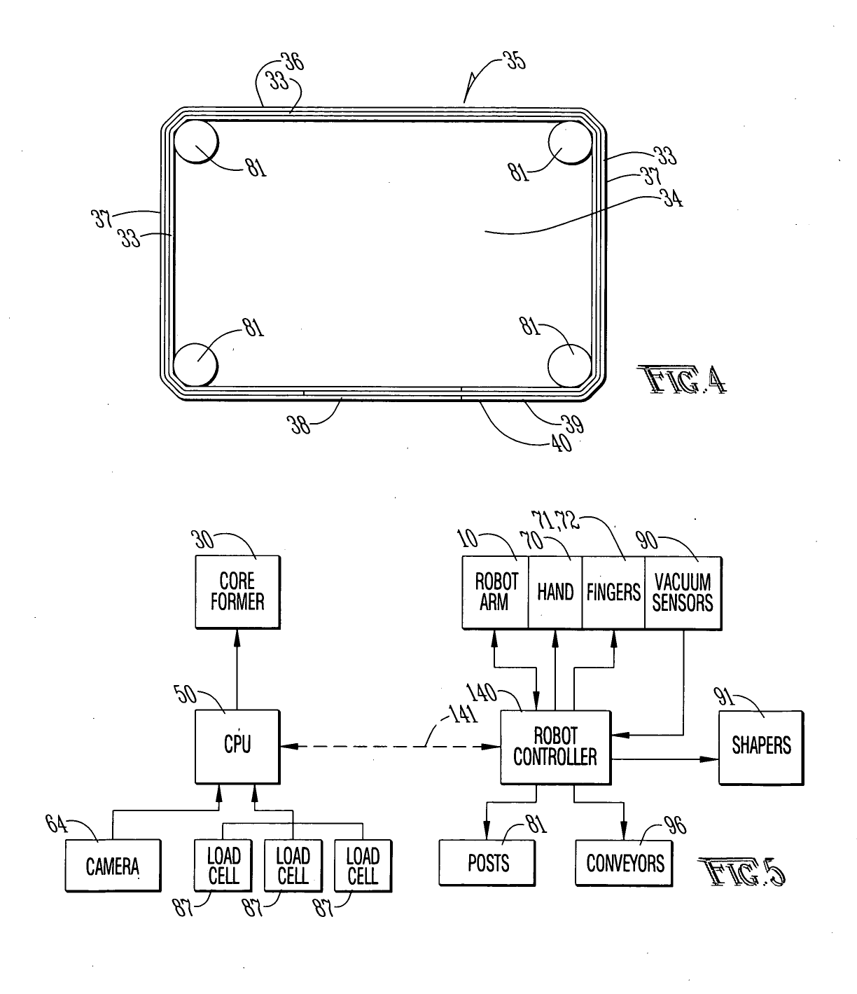

As shown in FIG. 6, one or more laser line projectors 60 are oriented toward the core former 30 at a right angle to the lamination 33 so as to place a vertical laser reference line 61 along the lamination 33. Depending on the placement of the laser line projectors 60, only a single projector 60 may be necessary to place the vertical laser reference line 61 along substantially the full length of the lamination 33. However, if a single laser line projector 60 cannot place a substantially full length laser line 61 due, for example, to the lamination 33 itself blocking the line of sight of the laser line projector 60, then more than one projector 60 may be employed to obtain a substantially full length laser reference line 61. As shown in FIG. 6, the laser line projectors 60 may be mounted on the core former 30 or the forming table 11.

From a head-on perspective, the reference line 61 appears straight, but due to creases 62 formed in the lamination 33 by the core former 30, from an angle to the side of the centerline of the core former 30, the vertical laser reference line 61 has a series of peaks 63 corresponding to the creases 62 in the lamination 33. A camera 64 located off the centerline of the core former 30 is able to visualize the peaks 63 in the laser reference line 61. This information is transmitted and interpreted by a machine vision system which calculates where the creases 62 are located in space with respect to a coordinate system based on the face plane of the core former 30. The machine vision system includes a set of executable instructions residing on the computer readable storage medium within the computer processing system (CPU) 50. The executable instructions residing on the robot controller 140 translate the coordinate system into robot coordinates based on the 6-axis robot arm 10 through training the finger positions and then calibrating the machine vision camera 64 with the robot arm 10. The system thus is able to direct the robot arm 10 to a position where it can grasp the laminations 33 securely as described following. At higher speeds of operation, it is possible that the lamination 33 may tend to move for a period of time following its production from the core former 30. In this situation, the machine vision system may have difficulty in capturing the position of the lamination 33. In one embodiment, an electromagnet (not shown) may be placed on the core former 30 alongside the exit area of the lamination 33. The electromagnet may be activated just before the core former 30 guillotine releases the lamination 33 thus stabilizing the position of the lamination 33 and allowing the laser 60 and camera 64 to capture the image faster and more accurately.

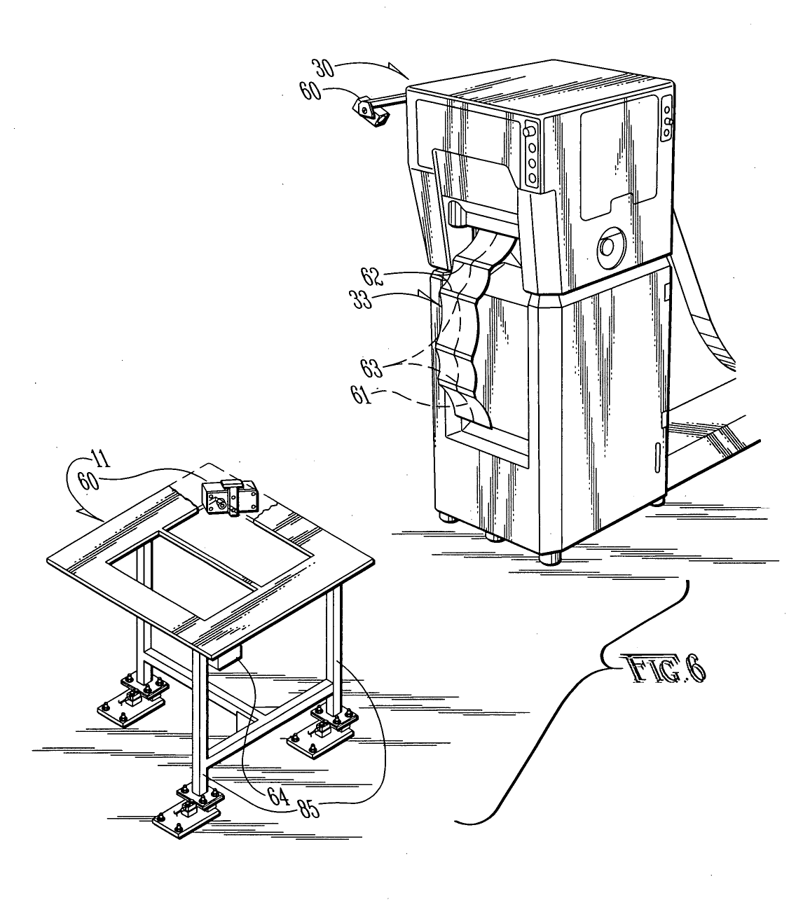

The laminations 33 are grasped by a tool at the end of the robot arm 10. As shown in FIG. 7, the tool comprises a hand 70 and fingers 71, 72. The robot arm 10 operates in two coordinate systems—one based on the core former 30 and the other based on the forming table 11. The location of the origin on the forming table 11 is “learned” by the robot arm 10 with the aid of an operator 41.

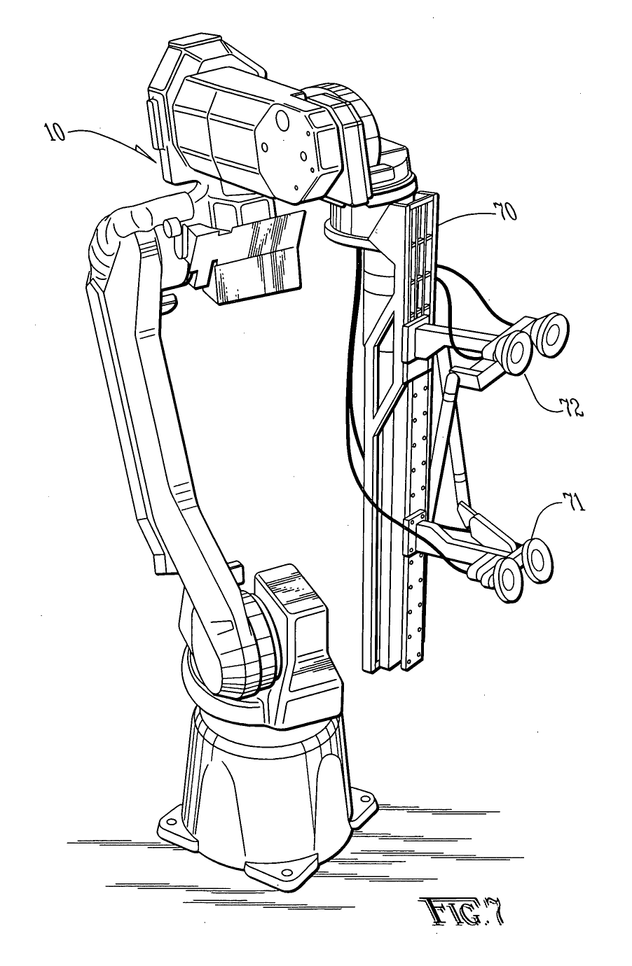

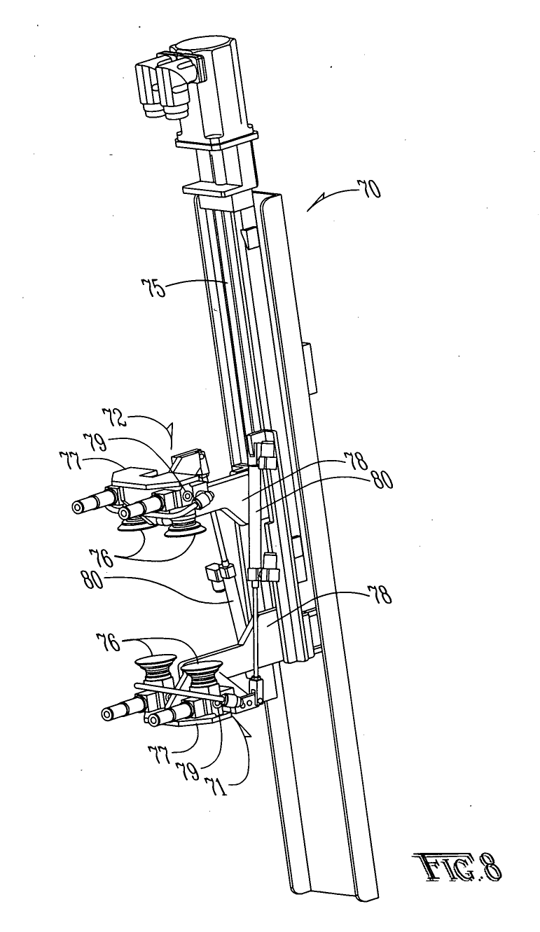

As shown in FIGS. 8 and 9, the hand 70 comprises an upper finger 72 and a lower finger 71.

As shown in FIG. 9, the upper finger 72 grasps the lamination 33 at an upper point 73 on one side of the lamination 33 near the crease between one side 37 and the back 36. The lower finger 71 grasps the lamination 33 at a corresponding lower point 74 on the opposite side of the lamination 33 near the crease between the opposite side 37 and the back 36. As each lamination 33 increases in size over the previous lamination, the vertical distance between the upper finger 72 and the lower finger 71 also increases so that the laminations 33 are grasped at the same locations despite the increase in length of the back 36 of each lamination 33. Grasping each lamination 33 at these points aids in forming the lamination 33 around the core 35 as described below. In one embodiment, the upper finger 72 is mechanically adjustable to either of two locations. The lower finger 71 is also mechanically adjustable to any one of three locations. The adjustments enable the distance between the fingers 71, 72 to be set for various sizes of cores 35 and laminations 33. In addition, either the lower finger 71 or the upper finger 72 is disposed on a linear actuator comprising a screw 75 driven by an auxiliary axis controlled by the robot controller 140 so that that the distance between the upper finger 72 and the lower finger 71 can be adjusted automatically from one lamination 33 to the next to accommodate for growth in the size of each lamination 33 throughout a core 35. In one embodiment, a change in size of up to 290 mm (11.4 inches) can be accommodated throughout the production of a core 35.

In one embodiment each of the fingers 71, 72 comprise a pair of vacuum cups 76 spaced apart horizontally on a gripper 77. The vacuum cups 76 should be suitable for use on oily metal surfaces. BFF-P Suction Cups (PIAB, Hingham, Mass.) have been found to be suitable for use in the practice of the present invention. The gripper 77 is mounted to the hand 70 by means of a bearing (not shown) that allows the gripper 77 to rotate to a limited degree. This rotation allows the gripper 77 to accommodate itself to some movement of the lamination 33 during the grasping process. A pair of vacuum cups 76 on each finger 71, 72 is desirable for stability in grasping the lamination 33. Each of the vacuum cups 76 is also provided with a vacuum sensor 90 so that the system is able to determine that the vacuum cups 76 have securely grasped the lamination 33.

In operation, the core former 30 produces a lamination 33 and then pauses before cutting the lamination 33 free from the roll of metal 31. Based on location information derived from the machine vision system—the laser line projector 60, the camera 64 and the set of executable instructions residing on the computer readable storage medium within the CPU 50—the lower finger 71 first contacts and grasps the lower point 74 on the lamination 33. The lower point 74 is grasped first since the lower end of the lamination 33 is free to move and thus is more susceptible to an alteration in the position of the point at which the lower finger 71 is directed to grasp the lamination 33. If the upper point 73 were grasped first, it is likely that the point toward which the lower finger 71 is directed would be moved by the act of grasping the upper point 73. The upper portion of the lamination 33 is more stable since it has not at this point in time been cut from the roll of metal 31 to which it remains attached. After the lower finger 71 has securely grasped the lamination 33 at the lower point 74, the upper finger 72 is rotated and translated so as to contact and grasp the lamination 33 at the upper point 73 while the lower finger 71 maintains its grip on the lamination 33 at the lower point 74.

The fingers 71, 72 are mounted on brackets 78 for rotation about pivots 79 toward each other. The rotation is produced by effectors such as pneumatic cylinders 80. Rotation of the fingers 71, 72 toward each other allow for the lamination 33 to be shaped about the stack of previously stacked laminations as described below.

Once both the upper finger 72 and the lower finger 71 have securely grasped the lamination 33 at the upper and lower points 73, 74, respectively, the final cut is made by the core former 30 freeing the lamination 33 from the roll of metal 31. The robot arm 10 then moves the lamination 33 from a position in which it is hanging vertically from the core former 30 to a position horizontally disposed above the forming table 11.

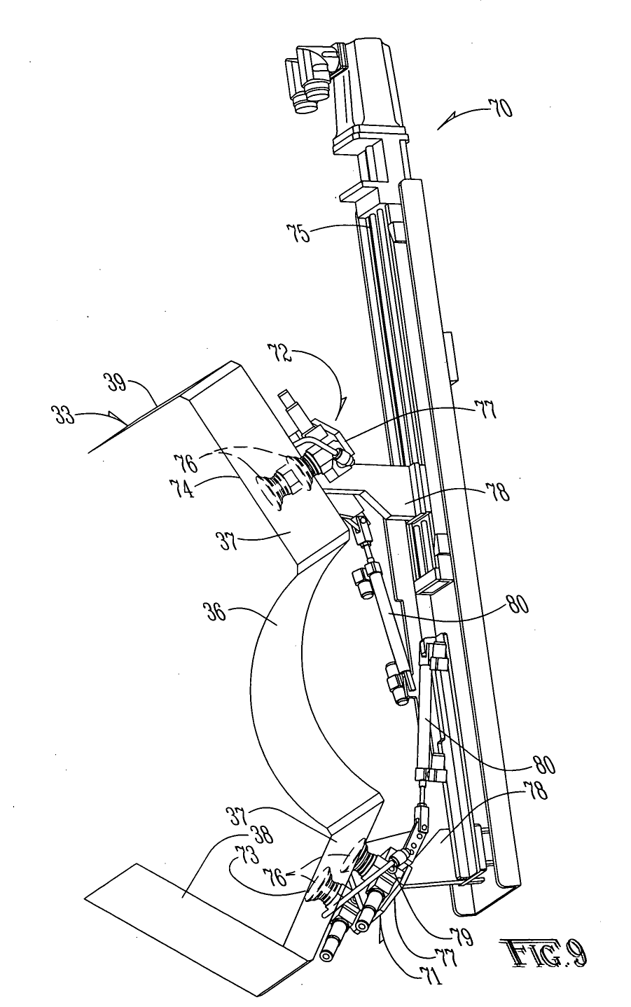

With reference to FIGS. 10-13, the forming table 11 is provided with four supporting surfaces 101, 102, 103, 104. Supporting surfaces 101, 104 are disposed on a left carriage 105, while supporting surfaces 102, 103 are disposed on a right carriage 106. The carriages 105, 106 are preferably an open framework supported and moving on slides, linear bearings or the like. The particular mechanisms to support and allow movement of the carriages 105, 106 are not critical to the present invention and may be any of various mechanisms well known to those of ordinary skill in the art. The faces of the supporting surfaces 101, 102, 103, 104 are disposed in a common plane 82 (also referred to herein as the surface of the forming table). Each supporting surface 101, 102, 103, 104 is provided with a forming post 81 extending vertically from the common plane 82. The four posts 81 are retractable into a respective cylinder 107 by effectors (not shown), such as pneumatic cylinders, solenoids and the like, so that in the fully retracted position they are disposed below the common plane 82 of the respective supporting surfaces 101, 102, 103, 104. The distances between the four forming posts 81 are adjustable, either manually or automatically, to accommodate the size of the window 34 of the transformer core 35 that is being formed. The distance between the pair of posts 81 disposed on left carriage 105 and the pair of posts 81 disposed on right carriage 106 may be adjustable, e.g. by a single manually operated screw mechanism 83. The distance between the pair of posts 81 disposed on supporting surfaces 101, 104 and the distance between the pair of posts 81 disposed on supporting surfaces 102, 103 may also be adjustable. In one embodiment the distances may be individually adjustable, e.g., each by a separate manually operated screw mechanism 84, or may be adjusted by the same mechanism so that the distances are always the same. Even if the distances between the each pair of posts are separately adjustable, in practice the distances will normally be the same. The carriages 105, 106 must be open at least in the vicinity of the forming posts 81 to allow movement of the forming posts 81 as described hereinafter.

The forming table 11 (also referred to herein as a “build table”) may be mounted on a base 85 having a plurality of legs 86. A load cell 87 is disposed beneath the lower end of each leg 86. Information from the load cells is transmitted to the CPU 50 to allow the calculation of the weight of a stack of laminations 33.

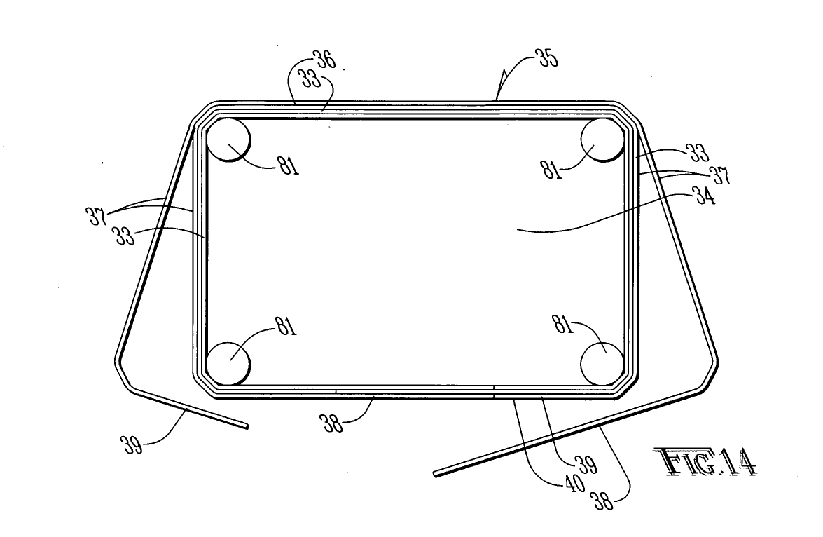

With the distances between the forming posts 81 set and the forming posts extended above the common plane 82 of the forming table 11, the robot arm 10, by appropriate rotation and translation, places the lamination 33 about the forming posts 81. The fingers 71, 72 are mounted for rotation toward each other to form the lamination 33 loosely around the forming posts 81 in a position that approximates the desired position of the lamination 33 on the stack of previously stacked laminations that constitute the partially formed core 35 as shown in FIG. 14. It is desirable that the finger 71, 72 nearest to the short front side 39 moves toward the other finger first and then the finger 71, 72 nearest to the long front side 38 moves toward the other finger next. This sequence of actions produces the tightest stack. The two sides 37 are brought into near contact with the sides of the previously placed lamination so that the lamination 33, that was originally more nearly linearly extended as it exited the core former 30 is more nearly box shaped as the fingers 71, 72 form it about the partially formed core 35.

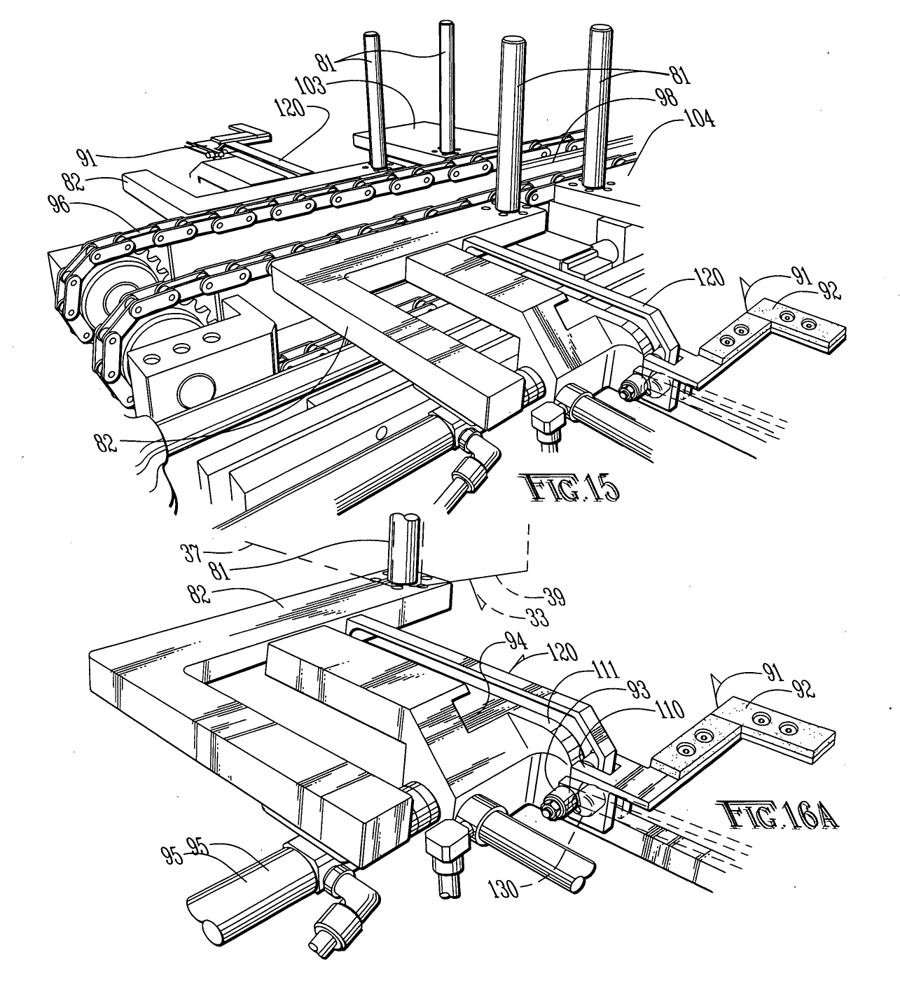

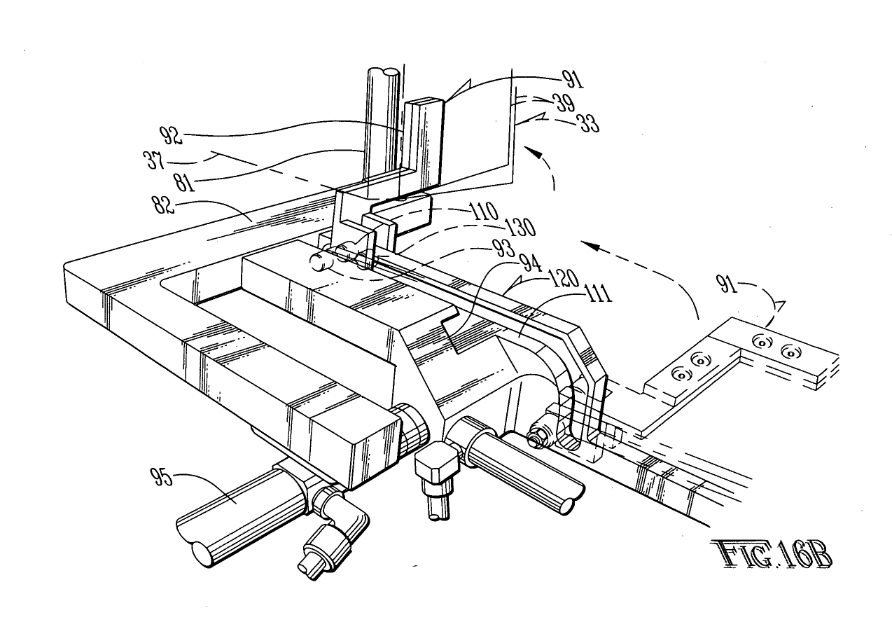

As shown in FIGS. 10 and 15, the forming table 11 also comprises an extended arm which, in the preferred embodiment, comprises a pair of shapers 91 (also referred to herein as “wipers”), one disposed on left carriage 105 and one disposed on right carriage 106 so a shaper 91 is disposed toward each side of the partially formed transformer core 35. The shapers 91 are actuated by effectors (not shown), such as pneumatic cylinders, solenoids or the like, so that they may be disposed below the common plane 82 of the forming table 11 to avoid interfering with the placement of the lamination 33 by the robot arm 10 about the partially formed core 35. As shown in FIGS. 16A-C, once the lamination 33 (shown in phantom outline) has been placed about the partially formed core 35 and the robot arm 10 retracted, the shapers 91 are moved by the pneumatic cylinders in a first motion that rotates the shapers 91 from a horizontal position below the common plane 82 as shown in FIG. 16A into a vertical position and then in a second motion that translates the shapers 91 horizontally into contact with the sides 37 of the lamination 33 as shown in FIG. 16B. With reference to FIGS. 15-18C, the motion of the shaper 91 is determined by rollers 110, 130 attached to the shaper 91 that follow a J-shaped channel 111 in shaper cam 120. (Shaper cam 120 is the shaper cam associated with the left carriage 105; the shaper cam associated with the right carriage 106 is a mirror image of the left shaper cam 120.) The J-shaped channel 110 comprises a circular section 113 and a straight section 112. The initial motion that brings the shaper 91 from a horizontal position to a vertical is determined by the circular section 113. After the shaper is in the vertical position, the second motion horizontally into contact with the lamination 33 is determined by the straight section 112.

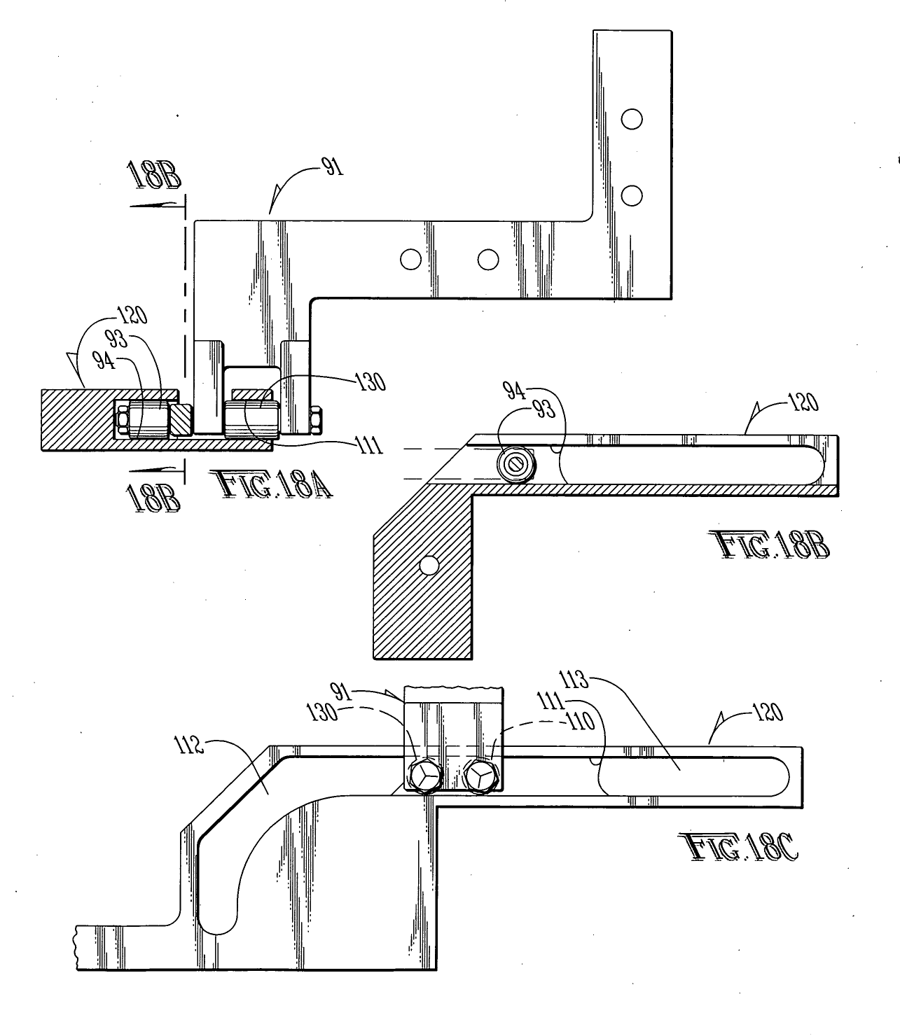

The shapers 91 are desirably provided with a degree of resilient compliance to ensure firm contact between the inner faces 92 of the shapers 91 and the sides 37 of the lamination 33. However, to avoid excessive compliance the shapers 91 also have a roller 93 as shown in FIGS. 18A and B that enters a horizontal channel 94 upon rotation of the shapers 91 into a vertical position. The horizontal channel 94 provides stability to the shaper 91 and ensures that it is supported into contact with the sides 37 of the lamination 33 as it is translated from the first vertical position to the position shown in FIG. 16B where the inner face 92 of the shaper 91 is in contact with the sides 37 of the lamination 33. Once the shapers 91 have contacted the sides 37 of the lamination 33, the shapers 91 (which together with the respective shaper cams are mounted for sliding motion along the sides of the lamination) are then moved laterally by pneumatic cylinders 95 so as to slide along the sides 37 of the lamination 33 and thereby pull the lamination 33 into snug contact with the partially formed core 35. The faces 92 of the shapers 91 must provide sufficient sliding friction to move the sides 37 of the laminations 33 into snug alignment with the partially formed core 35 but without excessive friction that would prevent the faces 92 of the shapers 91 from sliding along the sides 37 of the laminations 33. Acetal plastic has been found to provide the requisite coefficient of sliding friction. After forming the lamination 33, the shapers 91 are retracted to their first position below the surface 82 of the forming table 11 as shown in FIG. 16A.

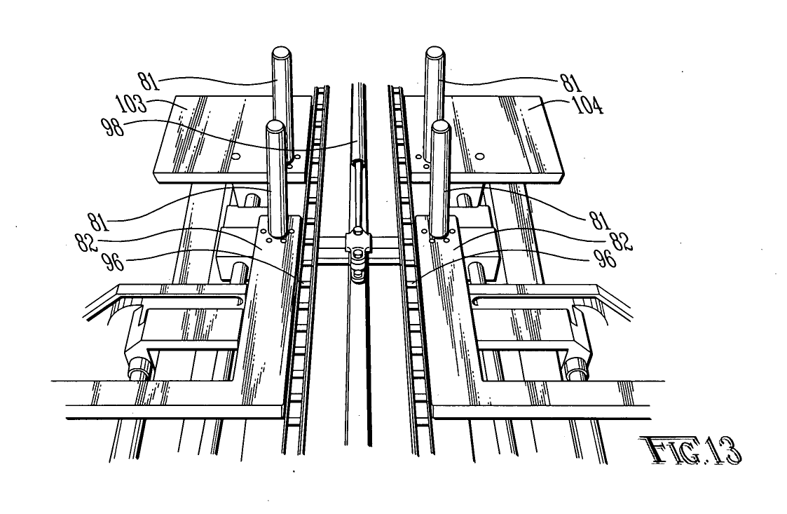

Once the lamination 33 has been snugly formed around the partially formed core 35, the core 35 is weighed. As noted above, the forming table 11 is mounted on a base 85 that is disposed on a series of load cells 87 that perform the weighing function. If the partially formed core 35 is found to weigh less than the desired weight, a signal is sent by the CPU 50 to the core former 30 to form the next lamination 33. The process is then repeated until a sufficient number of laminations 33 have been added to the core 35 to reach the desired weight. At this point, the forming posts 81 are retracted to a position below the common plane 82 of the forming table 11. The completed transformer core 35 rests on a pair of conveyors, such as chain conveyors 96, that are positioned slightly above the common plane 82 of the forming table 11 as shown in FIG. 13. The conveyors 96 are activated to move the formed core 35 off the forming table 11 onto an output conveyor 97 that conveys the core 35 to further processing stations. In addition to the pair of conveyors 96, the forming table 11 also includes a central rib 98 disposed between the pair of conveyors 96 to support the center of the core 35. The rib 98 is provided with a low friction surface disposed slightly below the tops of the pair of conveyors 96 so that the center of the formed core 35 is supported but nevertheless is allowed to slide off the forming table 11 when the pair of conveyors 96 are activated. The rib 98 may also be spring loaded so that its top surface is always disposed so that the pair of conveyors 96 bear most of the weight of the formed core 35 and therefore are able to move the formed core 35 off the forming table 11.

As outlined in the flow chart of FIGS. 1A-C, the operation of the system begins as shown in block 200 with confirming that the core former 30 and the robot arm 10 have power and booting the PC or CPU 50. The posts 81 are set as shown in block 201 to the desired dimensions of the window 34 of the transformer core 35 that is to be produced. The parameters of the desired transformer core 35, including dimensions, desired number of laminations and weight of the core 35 are input as shown in block 202 into the software consisting of the executable instructions residing on the computer processing system 50 and the robot controller 140. Operation of the core former 30 is begun as shown in block 203 and a lamination 33 is produced. The laser line projectors 60 project a reference line 61 as shown in block 204 on the lamination 33 produced by the core former 30. As shown in block 205, the camera 64 visualizes the line 61 and transmits this information to the executable instructions residing on the CPU 50 to determine the location of the lamination 33 and to instruct the robot arm 10 where to locate the lamination 33. The hand 70 and fingers 71, 72 of the robot arm 10 acquire the lamination 33 as shown in block 206 and move it as shown in block 207 to the forming table 11 where the lamination 33 is placed around the partially formed core 35 comprising the laminations previously stacked on the forming table 11 as shown in block 208. The fingers 71, 72 are closed as shown in block 209 to begin the process of shaping the lamination 33 around the partially formed core. As shown in block 210, the hand 70 then releases the lamination 33. The extended arm comprising the pair of shapers 91 is then activated as shown in block 211 to complete the process of shaping the lamination 33 around the partially formed core 35. If the preset number of laminations 33 has not been reached as shown in block 212, the fingers 71, 72 are indexed as shown in block 213 as necessary to acquire the next lamination formed by the core former 30. If the present number of laminations has been reached, a determination is then made from the reading provided by the load cells 87 if the preset core weight has been reached as shown in block 214. If so, the core 35 is completed as shown in block 215 and it is moved off the forming table 11 and onto the output conveyor 97 for further processing. If the preset core weight has not been reached, then the core former 30 is signaled to produce another lamination as shown in block 216 and the cycle proceeds until all preset parameters are satisfied.

The present invention has been described with reference to certain preferred and alternative embodiments that are intended to be exemplary only and not limiting to the full scope of the present invention as set forth in the appended claims.

What is claimed is:

1. An automated lamination stacking system for a transformer core former of the type that accepts information from an operator as to the parameters of a desired transformer core, receives a roll of sheet metal, determines the dimensions of each of a series of laminations and automatically forms and cuts the series of laminations that may be stacked to produce the desired core, comprising:
a robot arm;
a hand located at an end of said robot arm, said hand comprising at least one finger having grasping means for sequentially grasping each of the series of laminations;
forming means for sequentially receiving each of said series of laminations from said robot arm;
an extended arm means for shaping each lamination into a stack until the desired transformer core is formed; and
a set of executable instruction residing on a computer readable storage medium for interfacing with and controlling the automatic operation of the system.

2. The system of claim 1, further comprising machine vision means for locating each of the series of laminations formed by the core former.

3. The system of claim 1, further comprising means for adjusting a position of said at least one finger depending on the dimensions of the lamination.

4. The system of claim 1, wherein said grasping means comprises at least one vacuum cup.

5. The system of claim 4, wherein said vacuum cup is mounted on a rotatably mounted gripper.

6. The system of claim 5, further comprising vacuum sensor means for sensing that the vacuum cup has grasped the lamination.

7. The system of claim 4, wherein said at least one vacuum cup comprises a pair of vacuum cups.

8. The system of claim 1, wherein said at least one finger comprises an upper finger and a lower finger.

9. The system of claim 8, wherein said upper finger and said lower finger are each mounted for rotation toward each other and further comprise means for rotating said upper finger and said lower finger.

10. The system of claim 1, wherein said forming means comprises a forming table having a plurality of retractable forming posts and means for moving said forming posts between an extended position extending vertically above a surface of said forming table and a retracted position below said surface of said forming table.

11. The system of claim 10, further comprising means for adjusting a horizontal distance between any two of said retractable forming posts.

12. The system of claim 1, wherein said extended arm means comprises at least one shaper and means for rotating said at least one shaper between among a first position wherein said at least one shaper is disposed below a surface of said forming table and a second position wherein said shaper is disposed substantially vertically above said surface of said forming table, means for translating said shaper horizontally into a third position in contact with a side of said each lamination, and means for translating said shaper laterally into a fourth position along said side of said each lamination while frictionally sliding along said side.

13. The system of claim 12, wherein said shaper further comprises an inner face disposed for frictional contact with said side of said lamination and having a sufficient coefficient of sliding friction to move said sides of said lamination into alignment with said stack.

14. The system of claim 1, further comprising means for weighing said stack.

15. The system of claim 2, wherein said each of said series of laminations comprises a formed lamination comprising a plurality of creases defining sides of said formed lamination and further wherein said machine vision means comprises at least one laser line projector disposed so as to project a vertical line of laser light onto said formed lamination, a camera disposed for viewing said line of laser light from an angle to said laser line projector, and wherein said set of executable instruction residing on a computer readable storage medium comprises a set of executable instructions for calculating a position associated with each of said creases.
